(19) United States
(12) Patent Application Publication
(10) Pub. No.: US 2014/0062785 A1
(43) Pub. Date: Mar. 6, 2014

(54) ANTENNA APPARATUS AND RADAR APPARATUS FOR IMPROVING RADIATION EFFICIENCY

(71) Applicant: MANDO CORPORATION, Pyeongtaek-si (KR)

(72) Inventors: Min Seok KIM, Anyang-si (KR); Seong Hee JEONG, Seoul (KR); Jae Eun LEE, Hwaseong-si (KR); Sung Joon HEO, Seoul (KR)

(73) Assignee: MANDO CORPORATION, Pyeongtaek-si (KR)

(21) Appl. No.: 14/017,227

(22) Filed: Sep. 3, 2013

(30) Foreign Application Priority Data
Sep. 3, 2012 (KR) 10-2012-0097028

(51) Int. Cl. G01S 7/292; H01Q 3/34

(52) U.S. Cl. CPC G01S 7/292; H01Q 3/34
USPC 342/368

(57) ABSTRACT

Disclosed is an antenna apparatus for improving radiation efficiency, which can radiate signals not having a radiation pattern where maximum radiation energy is emitted from the front side, but having a radiation pattern where maximum radiation energy is emitted from opposite lateral sides of the front side.

### CROSS-REFERENCE TO RELATED APPLICATION

This application claims priority from and the benefit under 35 U.S.C. §119 (a) of Korean Patent Application No. 10-2012-0097028, filed on Sep. 3, 2012, which is hereby incorporated by reference for all purposes as if fully set forth herein.

### BACKGROUND OF THE INVENTION

1. Field of the Invention

The present invention relates to an antenna apparatus and a radar apparatus.

2. Description of the Prior Art

An integrated radar apparatus is an apparatus capable of detecting both objects located at short distances and objects located at long distances.

Such an integrated radar apparatus radiates short-distance detection signals for short-distance detections and long-distance detection signals for long-distance detections.

Both the short-distance detection signals and the long-distance detection signals radiated from the conventional integrated radar apparatus have radiation patterns where maximum radiation energy is radiated from the front side.

Due to the radiation patterns, there exists an overlapping detection area where a short-distance detection area and a long-distance detection area of the conventional integrated radar apparatus overlap each other.

Due to the overlapping detection area existing in the conventional integrated radar apparatus, objects are detected repeatedly and accordingly signals are repeatedly processed, which deteriorates object detection efficiency.

### SUMMARY OF THE INVENTION

Accordingly, the present invention has been made to solve the above-mentioned problems occurring in the prior art, and an object of the present invention is to provide an antenna apparatus and a radar apparatus which can radiate signals not having a radiation pattern where maximum radiation energy is emitted from the front side, but having a radiation pattern where maximum radiation energy is emitted from opposite lateral sides of the front side.

It is another object of the present invention to provide an antenna apparatus and a radar apparatus which can radiate a short-distance detection signal and a long-distance detection signal so that both a short-distance object and a long-distance object can be efficiently detected without generating an overlapping detection area where a short-distance detection area and a long-distance detection area overlap each other in an integrated radar apparatus.

In accordance with an aspect of the present invention, there is provided an antenna apparatus for improving a radiation efficiency thereof, including: n antennas for radiating signals; a signal generator for generating the signals radiated through the n antennas; and a divider for dividing the signals generated by the signal generator and transferring the signals to the n antennas, wherein the n antennas are classified into a first antenna group comprising at least one antenna and a second antenna group comprising at least one antenna, wherein the divider comprises an input port connected to the signal generator, n output ports connected to the n antennas respectively, and signal lines for connecting the input port and the n output ports, wherein the signal lines comprise a dividing point where the signals input through the input port are divided into the output ports connected to the antennas included in the first antenna group and the output ports connected to the antennas included in the second antenna group, and wherein a signal line length of a first dividing section between the output ports connected to the antennas included in the first antenna group respectively and the dividing point and a signal line length of a second dividing section between the output ports connected to the antennas included in the second antenna group respectively and the dividing point are different.

In accordance with another aspect of the present invention, there is provided a radar apparatus, including: a signal generator for generating long-distance detection signals and short-distance detection signals; m long-distance detection antennas for radiating the long-distance detection signals; a long-distance detection divider for dividing the long-distance detection signals and transferring the signals to the m long-distance detection antennas; n short-distance detection antennas for radiating the short-distance detection signals; and a short-distance detection divider for dividing the short-distance detection signals and transferring the signals to the n short-distance detection antennas, wherein a length of a signal line through which the short-distance detection signals are transferred to at least one of the n short-distance detection antennas is different from lengths of signal lines through which the short-distance detection signals are transferred to the other n short-distance detection antennas, and wherein lengths of the signal lines through which the long-distance detection signals are transferred to the m long-distance detection antennas are the same.

As described above, according to the present invention, an antenna apparatus and a radar apparatus can radiate signals not having a radiation pattern where maximum radiation energy is emitted from the front side, but having a radiation pattern where maximum radiation energy is emitted from opposite lateral sides of the front side.

Further, according to the present invention, an antenna apparatus and a radar apparatus can radiate a short-distance detection signal and a long-distance detection signal so that both a short-distance object and a long-distance object can be efficiently detected without generating an overlapping detection area where a short-distance detection area and a long-distance detection area overlap each other in an integrated radar apparatus.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing an antenna apparatus for improving a radiation efficiency thereof according to an embodiment of the present invention;

FIG. 2 is a view showing a radiation pattern of radiated signals when structural characteristics of a signal line, which is the signal transfer path, according to the embodiment of the present invention exist;

FIG. 3 is a view showing a radiation pattern of radiated signals when structural characteristics of a signal line which is a signal transfer path according to the embodiment of the present invention do not exist;

FIG. 4 shows graphs of radiation patterns of radiated signals when structural characteristics of a signal line which is a signal transfer path according to the embodiment of the present invention exists and do not exist;

FIG. 5 is a view exemplifying a short-distance detection signal transmitting part of the antenna apparatus when n is 2;

FIG. 6 is a view exemplifying a short-distance detection signal transmitting part of the antenna apparatus when n is 4; and

FIGS. 7A and 7B are views showing detection areas for an integrated radar apparatus including the antenna apparatus according to the embodiment of the present invention, having the structural characteristics of the signal line at the short-distance detection signal transmitting part, and an integrated radar apparatus including the antenna apparatus according to the related art, not having the structural characteristics of the signal line at the short-distance detection signal transmitting part.

### DETAILED DESCRIPTION OF THE PREFERRED EMBODIMENTS

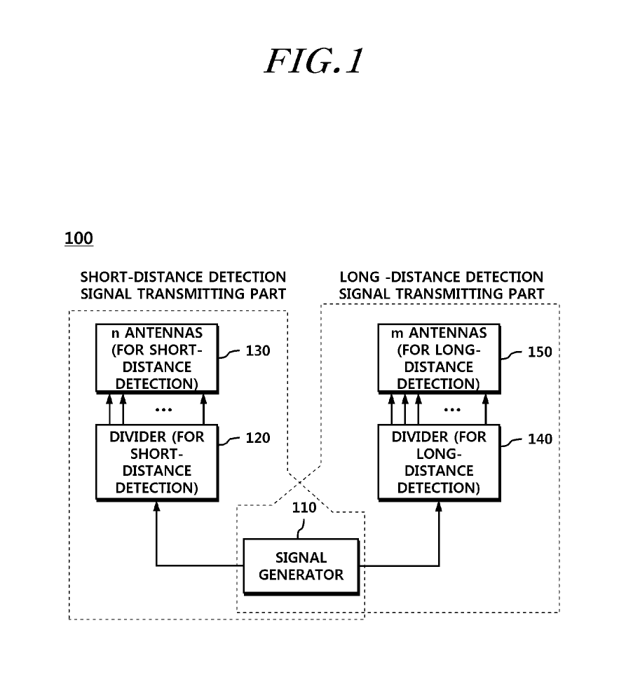

FIG. 1 is a block diagram showing an antenna apparatus for improving a radiation efficiency thereof according to an embodiment of the present invention.

Referring to FIG. 1, an antenna apparatus 100 for improving a radiation efficiency thereof according to an embodiment of the present invention includes n antennas 130 for radiating signals, a signal generator 110 for generating the signals radiated through the n antennas, and a divider 120 for dividing the signals generated by the signal generator 110 to transfer the signals to the n antennas 130.

The n antennas 130 are classified into a first antenna group including at least one antenna and a second antenna group including at least one antenna. Here, n may be an even number such as two, four, and the like.

For example, if the n antennas 130 are disposed on the left and right sides, n/2 antennas ANT₁, . . . ANT_{n/2} disposed on the left side may be classified into the first antennas group, and n/2 antennas ANT_{n/2+1}, . . . ANTₙ disposed on the right side may be classified into the second antennas group. If the n antennas 130 are disposed on the upper and lower sides, n/2 antennas ANT₁, . . . , ANT_{n/2} disposed on the upper side may be classified into the first antennas group, and n/2 antennas ANT_{n/2+1}, . . . , ANTₙ disposed on the lower side may be classified into the second antennas group.

The divider 120 for dividing the signals generated by the signal generator 110 to transfer the divided signals to the n antennas 130 includes an input port P_{In} connected to the signal generator 110, n output ports P_{OUT1}, P_{OUT2}, . . . , P_{OUTn} connected to the n antennas 130 respectively, and a signal line connecting the input port P_{I}, with the n output port P_{OUT1}, P_{OUT2}, . . . , P_{OUTn} to act as a signal transfer path.

The signal line, which is the signal transfer path, has a dividing point T for dividing signals input through the input port P_{In} toward the output ports P_{OUT1}, . . . , P_{OUT(n/2)} connected to the antennas included in the first antenna group and the output ports P_{OUT(n/2+1)}, . . . , P_{OUTn} connected to the antennas included in the second antenna group.

The antenna apparatus 100 according to the embodiment of the present invention has structural characteristics of the signal line where a signal line length of a first dividing section between the output ports P_{OUT1}, . . . , P_{OUT(n/2)} connected to the antennas ANT₁, . . . , ANT_{n/2} included in the first antenna group respectively and the dividing point T and a signal line length of a second dividing section between the output ports P_{OUT(n/2+1)}, . . . , P_{OUTn} connected to the antennas ANT_{n/2+1}, . . . , ANTₙ included in the second antenna group respectively and the dividing point T are different.

Due to the structural characteristics of the signal line, a phase difference between signals transferred through the first dividing section and radiated through the antennas ANT₁, . . . , ANT_{n/2} included in the first antenna group respectively and signals transferred through the second dividing section and radiated through the antennas ANT_{n/2+1}, . . . , ANTₙ included in the second antenna group respectively becomes 180 degrees.

Due to the structural characteristics of the signal line, a difference between a transfer path length of signals transferred from an interior of the antenna apparatus 100 before signals are radiated through the antennas ANT₁, . . . , ANT_{n/2} included in the first antenna group respectively and a transfer path length of signals transferred from an interior of the antenna apparatus 100 before signals are radiated through the antennas ANT_{n/2+1}, . . . , ANTₙ included in the second antenna group respectively becomes a length value corresponding to a phase difference of 180 degrees.

When the antenna apparatus 100 is designed, the signal line is designed such that a difference between the signal line length of the first dividing section between the output ports P_{OUT1}, . . . , P_{OUT(n/2)} connected to the antennas ANT₁, . . . , ANT_{n/2} included in the first antenna group respectively and the dividing point T and the signal line length of the second dividing section between the output ports P_{OUT(n/2+1)}, . . . , P_{OUTn} connected to the antennas ANT_{n/2+1}, . . . , ANTₙ included in the second antenna group respectively and the dividing point T is a length value corresponding to a phase difference of 180 degrees so that a phase difference between the signals transferred through the first dividing section and radiated through the antennas ANT₁, . . . , ANT_{n/2} included in the first antenna group respectively and the signals transferred through the second dividing section and radiated through the antennas ANT_{n/2+1}, . . . , ANTₙ included in the second antenna group respectively is 180 degrees.

As an example of the signal line design, a curved signal line point B may exist in one of the first dividing section between the output ports P_{OUT1}, . . . , P_{OUT(n/2)} connected to the antennas ANT₁, . . . , ANT_{n/2} included in the first antenna group respectively and the dividing point T, and the second dividing section between the output ports P_{OUT(n/2+1)}, . . . P_{OUTn} connected to the antennas ANT_{n/2+1}, . . . , ANTₙ included in the second antenna group respectively and the dividing point T so that a difference between the signal line length of the first dividing section between the output ports P_{OUT1}, . . . , P_{OUT(n/2)} connected to the antennas ANT₁, . . . , ANT_{n/2} included in the first antenna group respectively and the dividing point T, and the signal line length of the second dividing section between the output ports P_{OUT(n/2+1)}, . . . , P_{OUTn} connected to the antennas ANT_{n/2+1}, . . . , ANTₙ included in the second antenna group respectively and the dividing point T becomes a length value corresponding to a phase difference of 180 degrees. Here, the curved signal line point B serves to generate a difference between the signal transfer path lengths to generate a phase difference of 180 degrees.

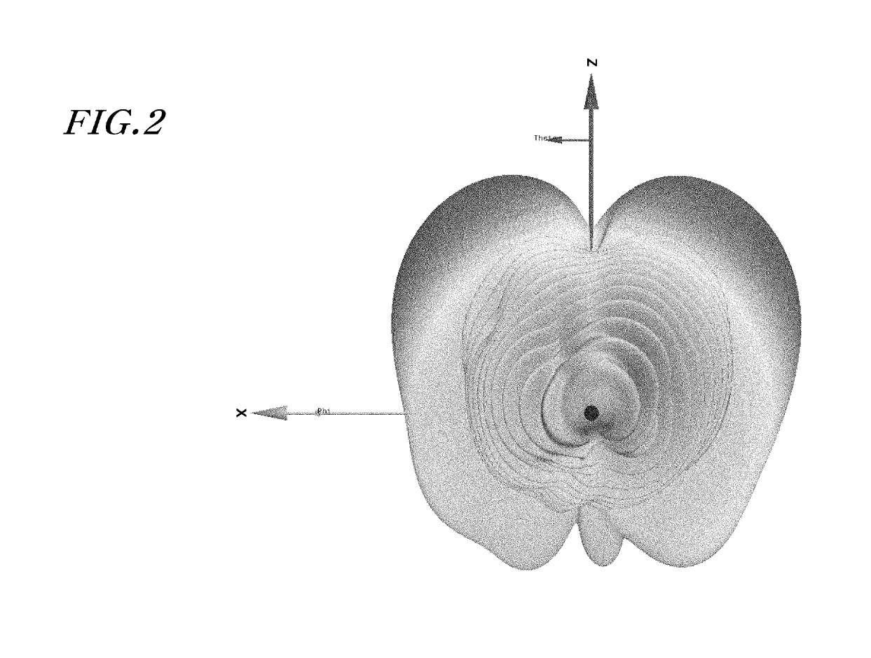

Due to the above-described structural characteristics of the signal line, a radiation pattern of signals radiated through the n antennas 130 will be described as follows with reference to FIG. 2.

FIG. 2 is a view showing a radiation pattern of radiated signals when the structural characteristics of the signal line, which is the signal transfer path, according to the embodiment of the present invention exist.

Referring to FIG. 2, due to the above-described structural characteristics of the signal line, that is, the structural characteristics where the signal line length of the first dividing section between the output ports P_{OUT1}, . . . , P_{OUT(n/2}) connected to the antennas ANT₁, . . . , ANT_{n/2} included in the first antenna group respectively and the dividing point T, and the signal line length of the second dividing section between the output ports P_{OUT(n/2+1)}, . . . , P_{OUTn} connected to the antennas ANT_{n/2+1}, . . . , ANTₙ included in the second antenna group respectively and the dividing point T are different, the signals radiated through the n antennas 130 have a radiation pattern where maximum radiation energy is radiated at opposite lateral sides of a front side.

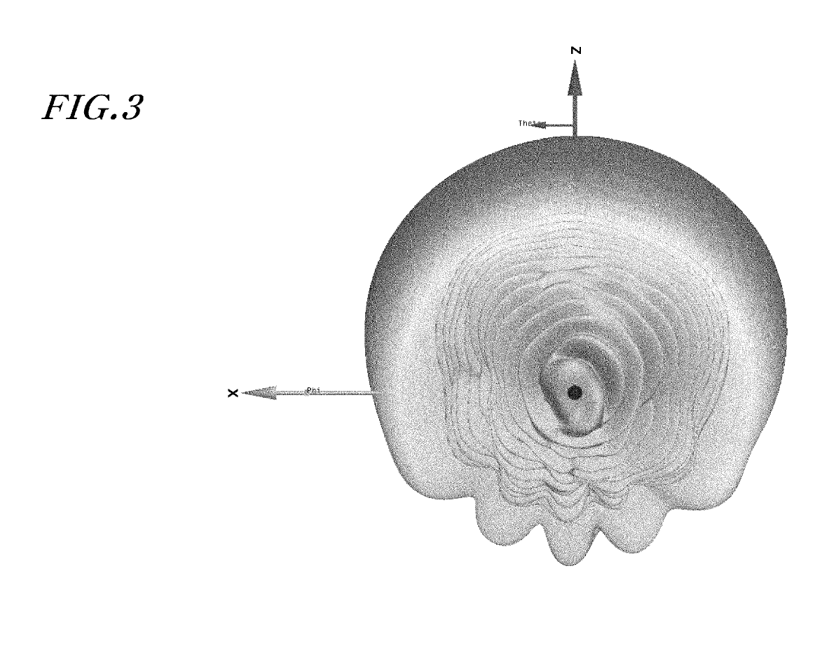

When the above-described structural characteristics of the signal line does not exist, that is, when the signal line length of the first dividing section between the output ports P_{OUT1}, . . . , P_{OUT(n/2)} connected to the antennas ANT₁, . . . , ANT_{n/2} included in the first antenna group respectively and the dividing point T, and the signal line length of the second dividing section between the output ports P_{OUT(n/2+1)}, . . . , P_{OUTn} connected to the antennas ANT_{n/2+1}, . . . , ANTₙ included in the second antenna group respectively and the dividing point T are identical, the signals radiated through the n antennas 130 do not have the radiation pattern where maximum radiation energy is radiated at opposite lateral sides of a front side as shown in FIG. 2, but have a radiation pattern where maximum radiation energy is radiated at the front side as shown in FIG. 3.

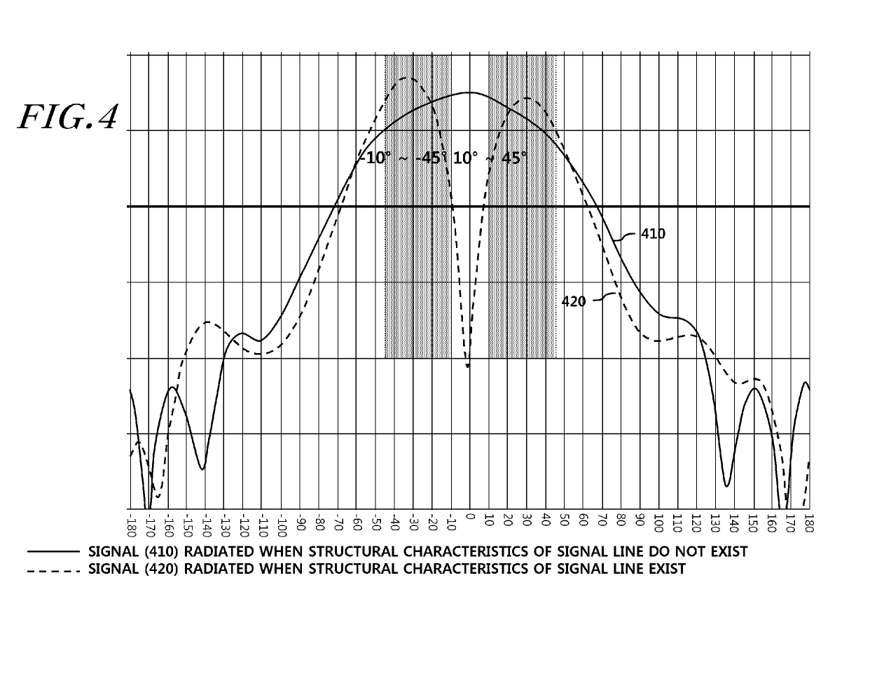

FIG. 4 is a graph (the x-axis: angle, the y-axis: signal intensity) showing the radiation pattern of the signal radiated through the n antennas 130 when the structural characteristics of the signal line, which is the signal transfer path, according to the embodiment of the present invention exist, and the radiation pattern of the signal radiated through the n antennas 130 when the structural characteristics of the signal line, which is the signal transfer path, according to the embodiment of the present invention do not exist.

As shown in FIG. 4, when the structural characteristics of the signal line, which is the signal transfer path, according to the embodiment of the present invention do not exist, that is, when the signal line length of the first dividing section and the signal line length of the second dividing section are identical, that is, when the length of the signal transfer path in the antenna apparatus 100 of the signals radiated through the antennas included in the first antenna group and the length of the signal transfer path in the antenna apparatus of the signals radiated through the antennas included in the second antenna group are identical, the signals 410 radiated through the n antennas have a radiation pattern where maximum radiation energy is radiated at a front side (an angle thereof is 0°). The antenna apparatus according to the related art has such a radiation pattern.

Meanwhile, as shown in FIG. 4, when the structural characteristics of the signal line, which is the signal transfer path, according to the embodiment of the present invention exist, that is, when the signal line length of the first dividing section and the signal line length of the second dividing section are different, that is, when the length of the signal transfer path in the antenna apparatus 100 of the signals radiated through the antennas included in the first antenna group and the length of the signal transfer path in the antenna apparatus of the signals radiated through the antennas included in the second antenna group are different, the signals 420 radiated through the n antennas 130 have a radiation pattern where maximum radiation energy is radiated at opposite lateral sides of the front side (an angle thereof is 0 degree). That is, in an experimental result, the maximum radiation energy is radiated in an angle range between −10° and −45° and in an angle range between 10° and 45°.

Meanwhile, the antenna apparatus 100 according to the embodiment of the present invention may be included in an integrated radar apparatus which can synthetically detect objects located in a short-distance detection area and a long-distance detection area.

In this case, the n antennas 130 are short-distance detection antennas, and signals radiated through the n antennas 130, which are the short-distance detection antennas, become short-distance detection signals for detecting objects located at short distances.

The divider 120 is a dividing and transferring unit for the short-distance detection signals, for dividing the short-distance detection signals generated by the signal generator 110 and for transferring the divided short-distance detection signals to the n antennas 130 which are the short-distance detection antennas, respectively.

A module for generating the short-distance detection signals through the signal generator 110, the divider 120 which is a unit for dividing and transferring the short-distance detection signals, and the n antennas 130 which are the short-distance detection antennas are referred to as a short-distance detection signal transmission part.

If the antenna apparatus 100 according to the embodiment of the present invention is an antenna apparatus included in the integrated radar apparatus which can integratedly detect objects located at the short-distance detection area and the long-distance detection area, the antenna apparatus 100 includes a long-distance detection signal transmission part for transmitting long-distance detection signals for detecting objects located at long distances in addition to the short-distance detection signal transmission part.

The long-distance detection signal transmission part includes a module for generating the long-distance detection signals in the signal generator 110, m antennas 150, which are long-distance detection antennas for radiating the long-distance detection signals, and a divider 140 which is a dividing and transferring unit for the long-distance detection signals, for dividing the long-distance detection signals generated by the signal generator 110 and for transferring the long-distance detection signals to the m antennas 150 which are the long-distance detection antennas. Here, m which is the number of the long-distance detection antennas 150 is larger than n which is the number of the short-distance detection antennas 130. That is, the long-distance detection antennas 150 include more antennas than the short-distance detection antennas 130.

The divider 140, which is a unit for dividing and transferring the long-distance detection signals, includes an input port p_{IN} connected to the signal generator 110, m output ports p_{OUT1}, . . . , p_{OUTm} connected to the m antennas, which are the long-distance detection antennas, respectively and signal lines for connecting the input port p_{IN} to the m output ports p_{OUT1}, . . . , p_{OUTm}.

In the divider 140, all signal line lengths of the signal lines through which the long-distance detection signals are transferred to the m antennas 150, which are the long-distance detection antennas, are identical. That is, all signal transfer path lengths transferred from an interior of the antenna apparatus 100 before signals are radiated through the m antennas 150 respectively are identical.

Accordingly, there is no phase difference between the long-distance detection signals radiated through the m antennas 150, which are the long-distance detection antennas, respectively. Accordingly, the long-distance detection signals have the radiation pattern where maximum radiation energy is radiated at the front side as shown in FIG. 3.

In contrast, as described above, due to the structural characteristics of the signal lines in the divider 120, which is the unit for dividing and transferring the short-distance detection signals, the short-distance detection signals radiated through the n antennas 130, which are the short-distance detection antennas, include short-distance detection signals in which a phase difference between the signals corresponds to 180 degrees. Accordingly, as shown in FIG. 2, the short-distance detection signals have the radiation pattern where maximum radiation energy is radiated at the opposite lateral sides of the front side due to the above-described structural characteristics.

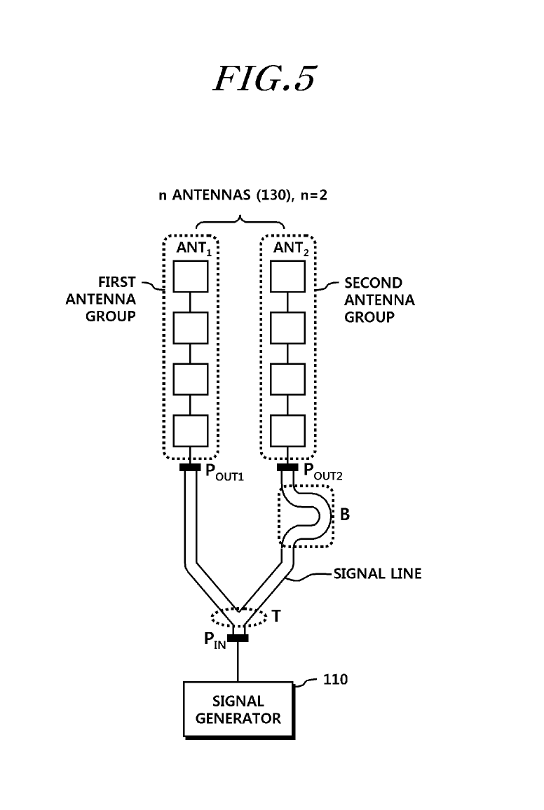

The above-described antenna apparatus 100 for improving radiation efficiency will be described below in more detail with respect to FIGS. 5 to 7.

FIG. 5 is a view exemplifying a short-distance detection signal transmitting part of the antenna apparatus 100 when n is 2.

Referring to FIG. 5, the short-distance detection signal transmitting part includes a signal generator 110 for transmitting short-distance detection signals, two antennas ANT₁ and ANT₂, and a divider 130 for dividing the short-distance detection signals generated by the signal generator 110 and for transferring the signals to the two antennas ANT₁ and ANT₂ respectively.

Among the two antennas ANT₁ and ANT₂, the antenna ANT′ is classified into a first antenna group and the antenna ANT₂ is classified into a second antenna group.

The divider 130, which is a unit for dividing and transferring the short-distance detection signals, will be described in more detail.

The divider 130 includes an input port P_{IN} connected to the signal generator 110, an output port P_{OUT1} connected to the antenna ANT₁ classified into the first antenna group, an output port P_{OUT2} connected to the antenna ANT₂ classified into the second antenna group, and signal lines where signals (short-distance detection signals) generated by the signal generator 110 and input to the input port P_{IN} are divided and transferred to the output ports P_{OUT1} and P_{OUT2}.

The signal lines, which are signal transfer paths of the short-distance detection signals, will be described in more detail.

The signal lines have a dividing point T where the signals (short-distance detection signals) generated by the signal generator 110 and input to the input port P_{IN} are divided.

In the signal lines, a signal line from the input port P_{IN} to the dividing point T is a common signal line section P_{IN} to T. A signal line from the dividing point T to the output port P_{OUT1} is a first dividing section T˜P_{OUT1}, and a signal line from the dividing point T to the output port P_{OUT2} is a second dividing section T to P_{OUT2}.

A curved signal line point B, which is not formed in the first dividing section T˜P_{OUT1}, is formed in the second dividing section T to P_{OUT2}.

Since the curved signal line point B is formed only in the second dividing section T to P_{OUT2}, a signal line length L_{T1} of the first dividing section and a signal line length L_{T2} of the second dividing section are different.

A difference ΔL_{T} (L_{T2}−L_{T1}) between the signal line length L_{T1} of the first dividing section T to P_{OUT1} and the signal line length L_{T2} of the second dividing section T to P_{OUT2} is a value corresponding to a phase difference of 180 degrees between a signal transferred through the first dividing section T to P_{OUT1} and radiated through the antenna ANT₁ and a signal transferred through the second dividing section T to P_{OUT2} and radiated through the antenna ANT₂.

In the divider 130, a signal transfer path of a signal radiated through the antenna ANT₁ classified into the first antenna group includes the common signal line P_{IN} to T and the first dividing section T to P_{OUT1}, and a signal transfer path of a signal radiated through the antenna ANT₂ classified into the second antenna group includes the common signal line P_{IN} to T and the second dividing section T to P_{OUT2}.

Accordingly, a difference ΔL (L_{I2}-L_{I1}) between a signal transfer path length Lₗ₁ of the signal radiated through the antenna ANT₁ classified into the first antenna group and a signal transfer path length Lₗ₂ of the signal radiated through the antenna ANT₂ classified into the second antenna group is the same as the difference ΔL_{T} (L_{T2}−L_{T1}) between the signal line length L_{T4} of the first dividing section T to P_{OUT1} and the signal line length L_{T2} of the second dividing section T to P_{OUT2} since the common signal line P_{IN} to T is commonly used and the signal transfer paths are different in the first dividing section T·P_{OUT1} and the second dividing section T˜P_{OUT2}.

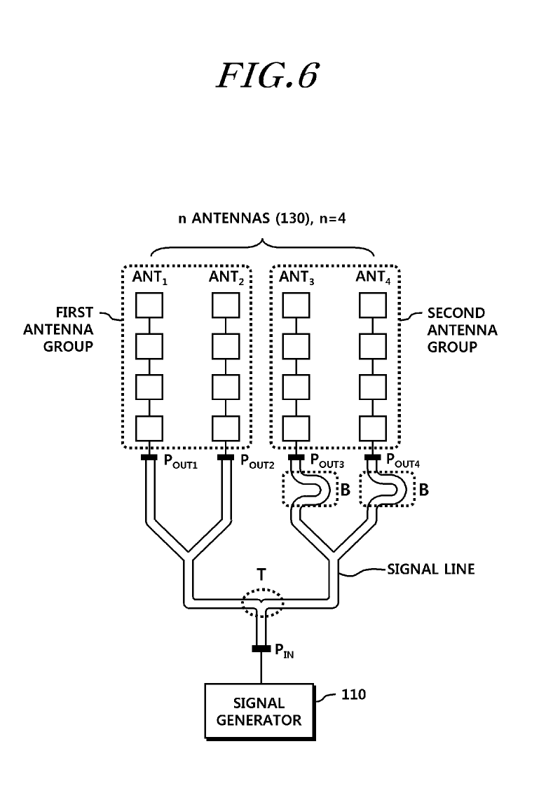

FIG. 6 is a view exemplifying a short-distance detection signal transmitting part of the antenna apparatus when n is 4.

Referring to FIG. 6, the short-distance detection signal transmitting part includes a signal generator 110 for transmitting the short-distance detection signals, four antennas ANT₁, ANT₂, ANT₂, and ANT₄, and a divider 130 for dividing the short-distance detection signals generated by the signal generator 110 and for transferring the signals to the four antennas ANT₁, ANT₂, ANT₂, and ANT₄.

Among the four antennas ANT₁, ANT₂, ANT₂, and ANT₄, the antennas ANT₁ and ANT₂ are classified into a first antenna group, and the antennas ANT₃ and ANT₄ are classified into a second antenna group.

The divider 130 for dividing and transferring the short-distance detection signal will be described in more detail.

The divider 130 includes an input port P_{IN} connected to the signal generator 110, an output port P_{OUT1} connected to the antenna ANT₁ classified into the first antenna group, an output port P_{OUT2} connected to the antenna ANT₂ classified into the first antenna group, an output port P_{OUT3} connected to the antenna ANT₃ classified into the second antenna group, and an output port P_{OUT4} connected to the antenna ANT₄ classified into the second antenna group.

The divider 140 further includes signal lines where signals (short-distance detection signals) generated by the signal generator 110 and input to the input port P_{IN} are divided into two parts to be transferred to the first antenna group ANT₁ and ANT₂ and the second antenna group ANT₃ and ANT₄ such that one divided signal is transferred to the output ports P_{OUT1} and P_{OUT2} respectively and the other divided signal is respectively transferred to the output ports P_{OUT3} and P_{OUT4}.

The signal lines, which are signal transfer paths of the short-distance detection signals, will be described in more detail.

The signal lines have a dividing point T where the signals (short-distance detection signals) generated by the signal generator 110 and input to the input port P_{IN} are divided into the two parts to be transferred to the first antenna group ANT₁ and ANT₂ and the second antenna group ANT₃ and ANT₄.

In the signal lines, a signal line from the input port P_{IN} to the dividing point T is a common signal line section P_{IN} to T through which signals radiated through the antenna ANT₁, signals radiated through the antenna ANT₂, signals radiated through the antenna ANT₃, and signals radiated through the antenna ANT₄ pass.

In the signal lines, a signal line from the dividing point T to the output port P_{OUT1} and a signal line from the dividing point T to the output port P_{OUT2} are first dividing sections T to P_{OUT1} and T to P_{OUT2}. A signal line from the dividing point T to the output port P_{OUT3} and a signal line from the dividing point T to the output port P_{OUT4} are second dividing sections T to P_{OUT3} and T to P_{OUT4}.

The second dividing sections T to P_{OUT3} and T to P_{OUT4} have curved signal line points B which do not exist in the first dividing sections T to P_{OUT1} and T to P_{OUT2}.

Since only the second dividing sections T to P_{OUT3} and T to P_{OUT4} have the curved signal line points B, a signal line length L_{T1} of the first dividing sections T to P_{OUT1} and T to P_{OUT2} and a signal line length L_{T2} of the first dividing sections T to P_{OUT3} and T to P_{OUT4} are different from each other.

The signal line T to P_{OUT1} from the dividing point T to the output port P_{OUT1} and the signal line T to P_{OUT2} from the dividing point T to the output port P_{OUT1} which are two kinds of the first dividing sections T to P_{OUT1} and T to P_{OUT2}, have the same length as a length L_{T1}.

The signal line T to P_{OUT3} from the dividing point T to the output port P_{OUT3} and the signal line T to P_{OUT4} from the dividing point T to the output port P_{OUT4}, which are two kinds of the second dividing sections T˜P_{OUT1} and T˜P_{OUT2}, have the same length as a length L_{T2}.

A difference ΔL_{T} (L_{T1}−L_{T2}) between the signal line length L_{T1} of the first dividing sections T to P_{OUT1} and T to P_{OUT2} and the signal line length L_{T2} of the second dividing sections T to P_{OUT2} and T to P_{OUT4} is a value corresponding to a phase difference of 180 degrees between a signal transferred through the first dividing sections T to P_{OUT1} and T to P_{OUT2} and radiated through the antennas ANT₁ and ANT₂ and a signal transferred through the second dividing sections T to P_{OUT3} and T to P_{OUT4} and radiated through the antennas ANT₃ and ANT₄.

In the divider 130, a signal transfer path of a signal radiated through the antenna ANT₁ classified into the first antenna group includes the common signal line P_{IN} to T and the first dividing section T to P_{OUT1}, and a signal transfer path of a signal radiated through the antenna ANT₂ classified into the first antenna group includes the common signal line P_{IN} to T and the first dividing section T to P_{OUT2}.

A signal transfer path of a signal radiated through the antenna ANT₃ classified into the second antenna group includes the common signal line P_{IN} to T and the second dividing section T to P_{OUT3}, and a signal transfer path of a signal radiated through the antenna ANT₄ classified into the second antenna group includes the common signal line P_{IN} to T and the second dividing section T to P_{OUT4}.

A signal transfer path length of the signal radiated through the antenna ANT₁ classified into the first antenna group and a signal transfer path length of the signal radiated through the antenna ANT₂ classified into the first antenna group have the same length as a length Lₗ₁, and a signal transfer path length of the signal radiated through the antenna ANT₃ classified into the second antenna group and a signal transfer path length of the signal radiated through the antenna ANT₄ classified into the second antenna group have the same length as a length Lₗ₂

Accordingly, a difference ΔL (L_{I2}−L_{I1}) between a signal transfer path length Lₗ₁ of the signals radiated through the antennas ANT₁ and ANT₂ classified into the first antenna group respectively and a signal transfer path length Lₗ₂ of the signals radiated through the antennas ANT₃ and ANT₄ classified into the second antenna group respectively is the same as the difference ΔL_{T} (L_{T2}−L_{T1}) between the signal line length L_{T1} of the first dividing sections T to P_{OUT1} and T to P_{OUT2} and the signal line length L_{T2} of the second dividing sections T to P_{OUT3} and T to P_{OUT4}, since the common signal line P_{IN} to T is commonly used and the signal transfer paths are different from in the first dividing sections T to P_{OUT1} and T to P_{OUT2} and the second dividing sections T to P_{OUT3} and T to P_{OUT4}.

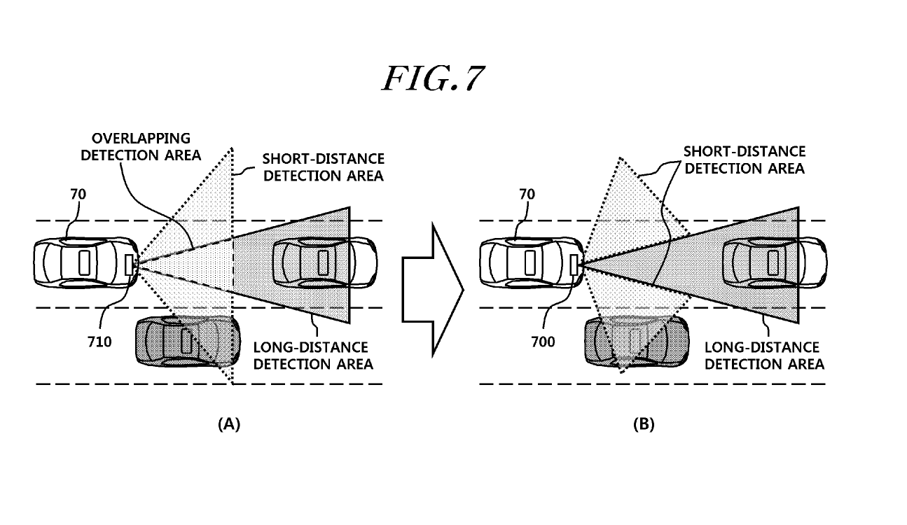

FIGS. 7A and 7B are views showing detection areas for an integrated radar apparatus 700 including the antenna apparatus 100 according to the embodiment of the present invention, having the structural characteristics of the signal line at the short-distance detection signal transmitting part, and an integrated radar apparatus 710 including the antenna apparatus according to the related art, not having the structural characteristics of the signal line at the short-distance detection signal transmitting part.

FIG. 7A is a view schematically showing a short-distance detection area and a long-distance detection area of the integrated radar apparatus 710 including the antenna apparatus according to the related art when the integrated radar apparatus 710 including the antenna apparatus according to the related art, not having the structural characteristics of the signal line at the short-distance detection signal transmitting part, is mounted to a vehicle 70.

FIG. 7B is a view schematically showing a short-distance detection area and a long-distance detection area of the integrated radar apparatus 700 including the antenna apparatus 100 according to the embodiment of the present invention when the integrated radar apparatus 700 including the antenna apparatus 100 according to the embodiment of the present invention, having the structural characteristics of the signal line at the short-distance detection signal transmitting part, is mounted to a vehicle 70.

Referring to FIG. 7A, the short-distance detection area and the long-distance detection area of the integrated radar apparatus 710 including the antenna apparatus according to the related art overlap each other. That is, the integrated radar apparatus 710 including the antenna apparatus according to the related art has an overlapping detection area where the short-distance detection area and the long-distance detection area thereof overlap each other.

In this way, the reason why the overlapping detection area exists is because both the short-distance detection signals and the long-distance detection signals radiated through the antenna apparatus according to the related art have the radiation pattern where maximum radiation energy is radiated at the front side, which is similar with the radiation pattern shown in FIG. 3.

Referring to FIG. 7B, the short-distance detection area and the long-distance detection area of the integrated radar apparatus 700 including the antenna apparatus 100 according to the embodiment of the present invention may not overlap each other, or an overlapping detection area thereof may be smaller than the overlapping detection area of FIG. 7A. That is, the integrated radar apparatus 700 including the antenna apparatus 100 according to the embodiment of the present invention may not have an overlapping detection area where the short-distance detection area thereof and the long-distance detection area thereof overlap each other, or may have a small overlapping detection area.

In this way, the reason why the overlapping detection area does not exist or is small is because the long-distance detection signals radiated through the antenna apparatus 100 according to the embodiment of the present invention have the radiation pattern where maximum radiation energy is radiated at the front side and the short-distance detection signals radiated through the antenna apparatus 100 according to the embodiment of the present invention have the radiation pattern where maximum radiation energy is radiated at the opposite lateral sides of the front side.

Due to the above-described structural characteristics (the length of the signal lines where the signals are transferred to the short-distance detection antennas included in the first antenna group and the length of the signal lines where the signals are transferred to the short-distance detection antennas included in the first antenna group are different from each other) of the signal lines in the divider 120 for dividing and transferring the short-distance detection signals, the short-distance detection signals radiated through the antenna apparatus 100 have the radiation pattern where maximum radiation energy is radiated at the opposite lateral sides of the front side.

Due to the above-described structural characteristics (the length of the signal lines where the signals are transferred to the long-distance detection antennas included in the first antenna group and the length of the signal lines where the signals are transferred to the long-distance detection antennas included in the first antenna group are identical with each other) of the signal lines in the divider 140 for dividing and transferring the long-distance detection signals, the long-distance detection signals radiated through the antenna apparatus 100 have the radiation pattern where maximum radiation energy is radiated at the opposite lateral sides of the front side.

As described above, according to the present invention, the antenna apparatus 100 can radiate the signals having the radiation pattern where maximum radiation energy is radiated not at the front side but at the opposite lateral sides of the front side.

Further, according to the present invention, the antenna apparatus 100 can radiate the short-distance detection signals and the long-distance detection signals such that short-distance objects and long-distance objects can be efficiently detected without the overlapping detection area where the short-distance detection area and the long-distance detection area overlap each other.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. An antenna apparatus for improving a radiation efficiency thereof, comprising:
n antennas for radiating signals;
a signal generator for generating the signals radiated through the n antennas; and
a divider for dividing the signals generated by the signal generator and transferring the signals to the n antennas,
wherein the n antennas are classified into a first antenna group comprising at least one antenna and a second antenna group comprising at least one antenna,
wherein the divider comprises an input port connected to the signal generator, n output ports connected to the n antennas respectively, and signal lines for connecting the input port and the n output ports,
wherein the signal lines comprise a dividing point where the signals input through the input port are divided into the output ports connected to the antennas included in the first antenna group and the output ports connected to the antennas included in the second antenna group, and
wherein a signal line length of a first dividing section between the output ports connected to the antennas included in the first antenna group respectively and the dividing point and a signal line length of a second dividing section between the output ports connected to the antennas included in the second antenna group respectively and the dividing point are different.

2. The antenna apparatus of claim 1, wherein the signal line length of the first dividing section and the signal line length of the second dividing section are different such that a phase difference between the signals transferred through the first dividing section and radiated through the antennas included in the first antenna group respectively and the signals transferred through the second dividing section and radiated through the antennas included in the second antenna group respectively is 180 degrees.

3. The antenna apparatus of claim 1, wherein one of the first dividing section and the second dividing section comprises a curved signal line point such that the signal line length of the first dividing section and the signal line length of the second dividing section are different.

4. The antenna apparatus of claim 1, wherein n is an even number.

5. The antenna apparatus of claim 1, wherein the signals radiated through the n antennas are short-distance detection signals where maximum radiation energy is radiated at opposite lateral sides of a front side.

6. The antenna apparatus for improving a radiation efficiency thereof of claim 5, comprising:
m antennas for radiating long-distance detection signals having a radiation pattern where maximum radiation energy is radiated at the front side; and
a divider for dividing the long-distance detection signals generated by the signal generator and transferring the signals to the m antennas,
wherein the divider comprises an input port connected to the signal generator, m output ports connected to the m antennas respectively, and a signal line for connecting the input port and the m output ports, and
wherein all signal line lengths of the signal lines through which the long-distance detection signals are transferred to the m antennas respectively are the same.

7. A radar apparatus, comprising:
a signal generator for generating long-distance detection signals and short-distance detection signals;
m long-distance detection antennas for radiating the long-distance detection signals;
a long-distance detection divider for dividing the long-distance detection signals and transferring the signals to the m long-distance detection antennas;
n short-distance detection antennas for radiating the short-distance detection signals; and
a short-distance detection divider for dividing the short-distance detection signals and transferring the signals to the n short-distance detection antennas,
wherein a length of a signal line through which the short-distance detection signals are transferred to at least one of the n short-distance detection antennas is different from lengths of signal lines through which the short-distance detection signals are transferred to the other n short-distance detection antennas, and
wherein lengths of the signal lines through which the long-distance detection signals are transferred to the m long-distance detection antennas are the same.
